(19) United States
(12) Patent Application Publication
(10) Pub. No.: US 2014/0045051 A1
(43) Pub. Date: Feb. 13, 2014

(54) NONAQUEOUS ELECTROLYTE SECONDARY BATTERY

(71) Applicant: SANYO Electric Co., Ltd., Osaka (JP)

(72) Inventors: Takayuki Hattori, Minamiawaji-shi (JP); Yoshinori Yokoyama, Itano-gun (JP); Eiji Okutani, Kasai-shi (JP); Yasuhiro Yamauchi, Sumoto-shi (JP)

(73) Assignee: SANYO ELECTRIC CO., LTD., Osaka (JP)

(21) Appl. No.: 13/962,181

(22) Filed: Aug. 8, 2013

(30) Foreign Application Priority Data
Aug. 9, 2012 (JP) 2012-176789

(51) Int. Cl. H01M 10/0563; H01M 10/052; H01M 2/02

(52) U.S. Cl. CPC H01M 10/0563; H01M 2/0262; H01M 10/052
USPC 429/185; 429/163

(57) ABSTRACT

A nonaqueous electrolyte secondary battery according to an embodiment of the present invention is a prismatic nonaqueous electrolyte secondary battery with a battery capacity not less than 15 Ah. The nonaqueous electrolyte secondary battery includes an electrode assembly, a nonaqueous electrolyte, and a container. The electrode assembly includes a positive electrode, a negative electrode, and a separator. The negative electrode is opposed to the positive electrode. The separator is disposed between the positive electrode and the negative electrode. The nonaqueous electrolyte contains lithium bis(oxalato)borate (LiBOB). The container houses the electrode assembly and the nonaqueous electrolyte. At least part of the container is formed using stainless steel.

### TECHNICAL FIELD

The present invention relates to a nonaqueous electrolyte secondary battery.

### BACKGROUND ART

In recent years, there have been various endeavors to use nonaqueous electrolyte secondary batteries in, for example, electric vehicles, hybrid cars, and the like. In such applications, the batteries are strongly required to have long life in addition to high output.

For example, JP-A-2009-245828 states that the cycling life of a nonaqueous electrolyte secondary battery is improved by adding lithium bis(oxalato)borate (LiBOB) to its nonaqueous electrolyte.

The inventors of the present invention have discovered, as a result of diligent researches, that although the cycling life of nonaqueous electrolyte secondary batteries is improved when LiBOB is added to their nonaqueous electrolyte, the thermal stability of the nonaqueous electrolyte secondary batteries will decline, and the battery interior will be prone to heat up, in the event of trouble due to external factors such as the battery being crushed. The inventors also have discovered that a battery with a large battery capacity of 15 Ah and over will be prone to heat up in the event of the aforementioned trouble. The inventors have arrived at the invention as a result of these discoveries.

### SUMMARY

A principal advantage of some aspects of the invention is to provide a nonaqueous electrolyte secondary battery that has improved thermal endurance.

A nonaqueous electrolyte secondary battery of an aspect of the invention is a prismatic nonaqueous electrolyte secondary battery with a battery capacity not less than 15 Ah. The nonaqueous electrolyte secondary battery of the invention includes an electrode assembly, a nonaqueous electrolyte, and a container. The electrode assembly includes a positive electrode, a negative electrode, and a separator. The negative electrode is opposed to the positive electrode. The separator is disposed between the positive electrode and the negative electrode. The nonaqueous electrolyte contains lithium bis(oxalato)borate (LiBOB). The container houses the electrode assembly and the nonaqueous electrolyte. At least part of the container is formed using stainless steel.

The invention enables provision of a nonaqueous electrolyte secondary battery that has improved thermal endurance.

### BRIEF DESCRIPTION OF THE DRAWINGS

The invention will be described with reference to the accompanying drawings, wherein like numbers reference like elements.

FIG. 1 is a simplified perspective view of a nonaqueous electrolyte secondary battery according to an embodiment of the invention.

FIG. 2 is a simplified sectional view through line II-II in FIG. 1.

FIG. 3 is a simplified sectional view through line III-III in FIG. 1.

FIG. 4 is a simplified sectional view through line IV-IV in FIG. 1.

FIG. 5 is a simplified sectional view of part of the electrode assembly in an embodiment of the invention.

### DESCRIPTION OF EXEMPLARY EMBODIMENTS

A preferred embodiment that implements the invention will now be described with reference to the accompanying drawings. However, the following embodiment is merely an illustrative example and does not limit the invention in any way.

In the accompanying drawings, to which reference will be made in describing the embodiment and other matters, members that have substantially the same functions are assigned the same reference numerals throughout. In addition, the accompanying drawings, to which reference will be made in describing the embodiment and other matters, are schematic representations, and the proportions of the dimensions of the objects depicted in the drawings may differ from the proportions of the dimensions of the actual objects. The proportions of the dimensions of the objects may differ among the drawings. The concrete proportions of the dimensions of the objects should be determined in view of the following description.

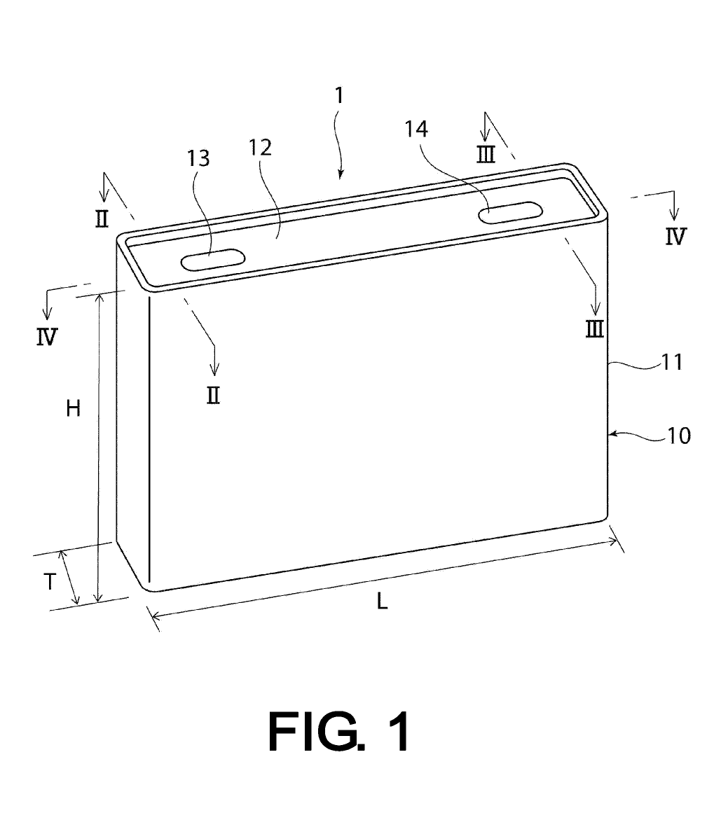

A nonaqueous electrolyte secondary battery 1 shown in FIG. 1 is a prismatic nonaqueous electrolyte secondary battery. The nonaqueous electrolyte secondary battery 1 can be used for any kind of application, and will preferably be used in an electric vehicle and a hybrid vehicle, for example. The capacity of the nonaqueous electrolyte secondary battery 1 is not less than 15 Ah, further preferably not less than 18 Ah, and still further preferably not less than 20 Ah. Normally, the capacity of the nonaqueous electrolyte secondary battery 1 will be not more than 50 Ah.

The “battery capacity” in this case means the capacity of the battery when the battery has been charged at a constant current of 1 It to a voltage of 4.1 V, then charged for 1.5 hours at a constant voltage of 4.1V, and then discharged at a constant current of 1 It to a voltage of 2.5 V.

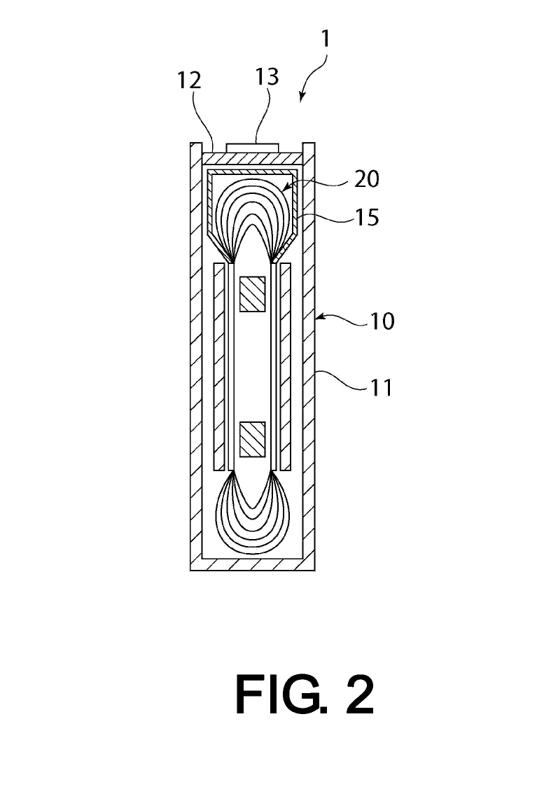

The nonaqueous electrolyte secondary battery 1 includes a container 10 shown in FIGS. 1 to 4, and an electrode assembly 20 shown in FIGS. 2 to 5. The nonaqueous electrolyte secondary battery 1 is a prismatic nonaqueous electrolyte secondary battery in which the container 10 is prismatic (parallelepiped) in shape. The length dimension L of the container 10 will preferably be 100 to 200 mm, and further preferably will be 140 to 180 mm. The thickness dimension T of the container 10 will preferably be 10 to 30 mm, and further preferably will be 20 to 28 mm. The height dimension H of the container 10 will preferably be 75 to 100 mm, and further preferably will be 80 to 95 mm. The ratio of the length dimension L of the container 10 to its height dimension H (L/H) will preferably be 1.0 to 2.5, and further preferably will be 1.5 to 2.2.

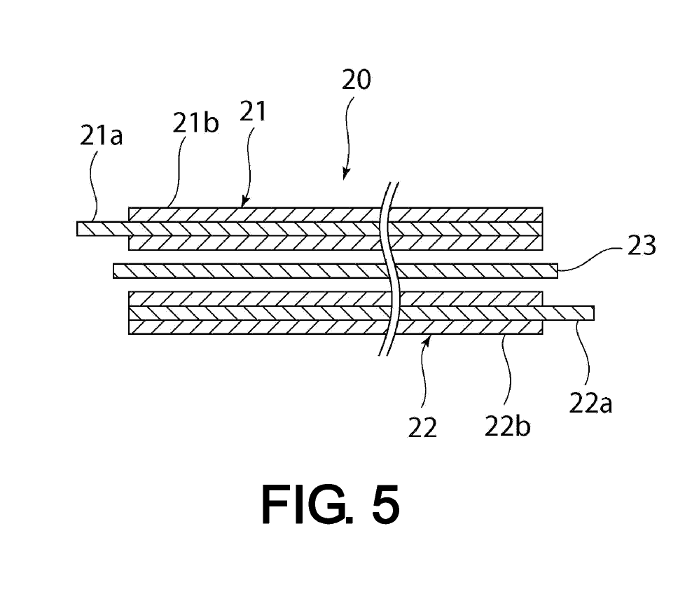

As shown in FIG. 5, the electrode assembly 20 includes the positive electrode 21, the negative electrode 22, and a separator 23. The positive electrode 21 and the negative electrode 22 are opposed to each other. The separator 23 is disposed between the positive electrode 21 and the negative electrode 22. The positive electrode 21, the negative electrode 22, and the separator 23 are wound and then pressed into a flattened shape. In other words, the electrode assembly 20 includes a flat wound positive electrode 21, negative electrode 22, and separator 23.

The positive electrode 21 includes a positive electrode substrate 21a and a positive electrode active material layer 21b. The positive electrode substrate 21a can be formed of aluminum, an aluminum alloy, or other materials. The positive electrode active material layer 21b is provided on at least one surface of the positive electrode substrate 21a. The positive electrode active material layer 21b contains a positive electrode active material. An example of the positive electrode active material that will preferably be used is a lithium oxide containing at least one of cobalt, nickel, and manganese. The following shows specific examples of such a lithium oxide containing at least one of cobalt, nickel, and manganese: lithium-containing nickel-cobalt-manganese complex oxides (LiNiₓCo_{y}Mn_{z}O₂, x+y+z=1, 0≦x≦1, 0≦y≦1, 0≦z≦1); lithium cobalt oxide (LiCoO₂); lithium manganese oxide (LiMn₂O₄); lithium nickel oxide (LiNiO₂); and a lithium-containing transition metal complex oxide such as a compound obtained by replacing part of the transition metal contained in these oxides with another element. Of these, lithium-containing nickel-cobalt-manganese complex oxides (LiNiₓCo_{y}Mn_{z}O₂, x+y+z=1, 0≦x≦1, 0≦y≦1, 0≦z≦1) and a lithium-containing transition metal complex oxide such as a compound obtained by replacing part of the transition metal contained in such oxide with another element will further preferably be used as the positive electrode active material. The positive electrode active material layer 21b may contain another component such as conductive material and binder as appropriate in addition to the positive electrode active material.

The negative electrode 22 includes a negative electrode substrate 22a and a negative electrode active material layer 22b. The negative electrode substrate 22a can be formed of copper, a copper alloy, or other materials. The negative electrode active material layer 22b is provided on at least one surface of the negative electrode substrate 22a. The negative electrode substrate 22a contains negative electrode active material. There is no particular limitation on the negative electrode active material, provided that it is able to reversibly absorb and desorb lithium. Examples of the negative electrode active material that will preferably be used are: carbon material, material that alloys with lithium, and metal oxide such as tin oxide. The following specific examples of carbon material can be cited: natural graphite, artificial graphite, mesophase pitch-based carbon fiber (MCF), mesocarbon microbeads (MCMB), coke, hard carbon, fullerene, and carbon nanotubes. Examples of material that can alloy with lithium are: one or more metals selected from the group consisting of silicon, germanium, tin, and aluminum, or an alloy containing one or more metals selected from the group consisting of silicon, germanium, tin, and aluminum. Of these, natural graphite, artificial graphite, and mesophase pitch-based carbon fiber (MCF) will further preferably be used as the negative electrode active material. The negative electrode active material layer 22b may contain another component such as conductive material and binder as appropriate in addition to the negative electrode active material.

The separator can be formed of a porous sheet of plastic such as polyethylene and polypropylene.

The electrode assembly 20 is housed inside the container 10. The nonaqueous electrolyte is also housed inside the container 10. The nonaqueous electrolyte contains lithium bis(oxalato)borate (LiBOB) as solute. Adding LiBOB to the nonaqueous electrolyte enables improvement of the cycling characteristics of the nonaqueous electrolyte secondary battery 1. The desirable additive amount of LiBOB in the interest of improving the cycling characteristics of the nonaqueous electrolyte secondary battery 1 will depend on the battery capacity of the nonaqueous electrolyte secondary battery 1. Specifically, a larger battery capacity of the nonaqueous electrolyte secondary battery 1 requires a larger desirable additive amount of LiBOB in the interest of improving the cycling characteristics of the nonaqueous electrolyte secondary battery 1. The battery capacity of the nonaqueous electrolyte secondary battery 1 is not less than 15 Ah. The content of LiBOB in the nonaqueous electrolyte of the nonaqueous electrolyte secondary battery 1 will preferably be not less than 0.05 mol/L, further preferably not less than 0.08 mol/L, and still further preferably not less than 0.10 mol/L, in the interest of improving the cycling characteristics of the nonaqueous electrolyte secondary battery 1. However, if the content of LiBOB in the nonaqueous electrolyte is too high, the nonaqueous electrolyte secondary battery 1 could heat up excessively in the event of trouble. In addition, the battery characteristics could decline due to increase in the internal resistance of the battery. Hence, the content of LiBOB in the nonaqueous electrolyte of the nonaqueous electrolyte secondary battery 1 will preferably be not more than 2 mol/L, and further preferably not more than 1 mol/L.

These preferable content ranges for LiBOB are based on the nonaqueous electrolyte in the nonaqueous electrolyte secondary battery immediately after assembly and before the first charging. The reason for providing such basis is that when a nonaqueous electrolyte secondary battery containing LiBOB is charged, its content level gradually declines. The cause of this is supposed to be that during charging, part of the LiBOB is consumed in formation of a covering on the negative electrode.

In addition to LiBOB, the nonaqueous electrolyte may contain as solute a substance such as: LiXF_{y} (where X is P, As, Sb, B, Bi, Al, Ga, or In, and y is 6 when X is P, As, or Sb, and y is 4 when X is B, Bi, Al, Ga, or In); lithium perfluoroalkyl sulfonic acid imide LiN(CₘF₂ₘ₊₁SO₂)(CₙF₂ₙ₊₁SO₂) (where m and n are independently integers from 1 to 4); lithium perfluoroalkyl sulfonic acid methide LiC(CₚF₂ₚ₊₁SO₂)(CᵣF₂ᵣ₊₁SO₂)(CᵣF₂ᵣ₊ᵢS0₂) (where p, q, and r are independently integers from 1 to 4); LiCF₃SO₃; LiClO₄; Li₂B₁₀Cl₁₀; and Li₂B₁₂Cl₁₂. Of these, the nonaqueous electrolyte may contain, as solute, at least one of LiPF₆, LiBF₄, LiN(CF₃SO₂)₂, LiN(C₂F₅SO₂)₂, LiN(CF₃SO₂)(C₄F₉SO₂), LiC(CF₃SO₂)₃, and LiC(C₂F₅SO₂)₃, for example. The nonaqueous electrolyte may contain as solvent, for example, cyclic carbonate, chain carbonate, or a mixture of cyclic carbonate and chain carbonate. Specific examples of cyclic carbonate are ethylene carbonate, propylene carbonate, butylene carbonate, and vinylene carbonate. Specific examples of chain carbonate are dimethyl carbonate, methylethyl carbonate, and diethyl carbonate.

The container 10 has a container body 11 and a sealing plate 12. The container body 11 is provided in the form of a rectangular tube of which one end is closed. In other words, the container body 11 is provided in the form of a bottomed square tube. The container body 11 has an opening. This opening is sealed up by the sealing plate 12. Thereby, the parallelepiped interior space is formed into a compartment. The electrode assembly 20 and the nonaqueous electrolyte are housed in this interior space. The thickness of the container body 11 will preferably be not less than 0.3 mm, and further preferably will be not less than 0.5 mm. The thickness of the container body 11 will preferably be not more than 2.0 mm, and further preferably will be not more than 1.5 mm. The thickness of the sealing plate 12 will preferably be not less than 1.0 mm, and further preferably will be not less than 1.3 mm. The thickness of the sealing plate 12 will preferably be not more than 2.0 mm, and further preferably will be not more than 1.6 mm.

A positive electrode terminal 13 and a negative electrode terminal 14 are connected to the sealing plate 12. The positive electrode terminal 13 and the negative electrode terminal 14 are each electrically insulated from the sealing plate 12 by insulating material not shown in the drawings.

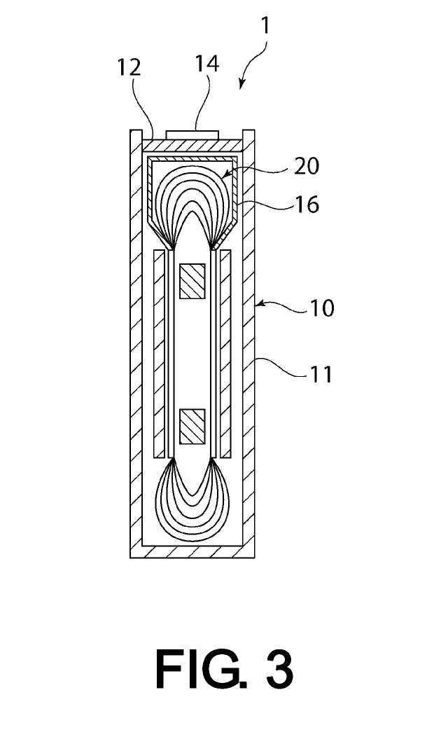

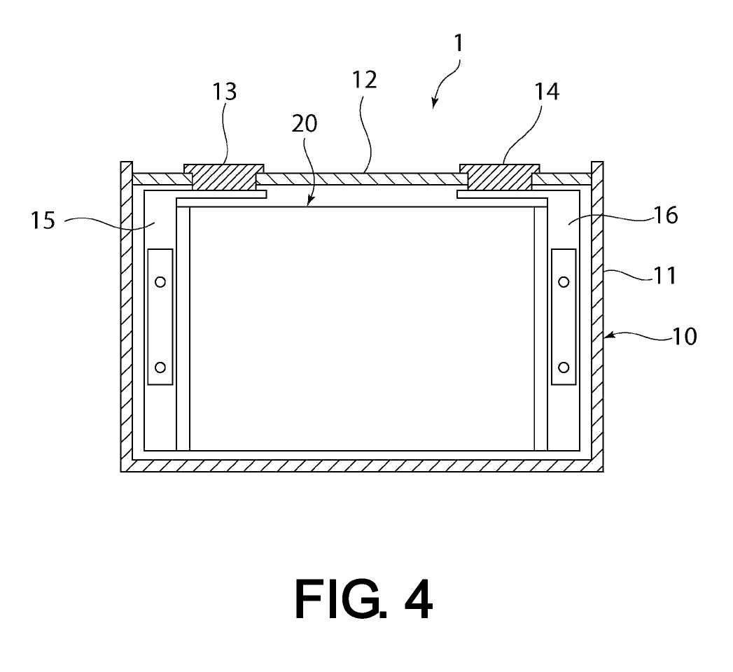

As shown in FIGS. 2 and 4, the positive electrode terminal 13 is electrically connected to a positive electrode substrate 21a of a positive electrode 21 by positive electrode collector 15. The positive electrode collector 15 can be formed of aluminum, an aluminum alloy, or other materials. As shown in FIGS. 2 and 3, the negative electrode terminal 14 is electrically connected to a negative electrode substrate 22a of a negative electrode 22 by negative electrode collector 16. The negative electrode collector 16 can be formed of copper, a copper alloy, or other materials.

In the related art, containers made of aluminum have long been used for prismatic nonaqueous electrolyte secondary batteries. This is because containers made of aluminum are easy to fabricate and moreover are light in weight. However, as mentioned above, the inventors have discovered, as a result of diligent researches, that in nonaqueous electrolyte secondary batteries with a large battery capacity of 15 Ah and over and with a large amount of LiBOB added to their nonaqueous electrolyte, the thermal stability will decline, and heat-up will be prone to occur, in the event of unanticipated battery trouble due to external factors such as the battery being crushed. When a container made of aluminum is used for such a high-capacity nonaqueous electrolyte secondary battery that contains a large amount of LiBOB, the problem arises that the container will reach high temperatures and be prone to be damaged during use of the nonaqueous electrolyte secondary battery. This is a problem that is unique to nonaqueous electrolyte secondary batteries that have a large battery capacity of 15 Ah and over and contain a large amount of LiBOB. Yet, such a problem will not arise during normal use. In addition, such a problem does not arise in, for example, nonaqueous electrolyte secondary batteries that have no LiBOB added or nonaqueous electrolyte secondary batteries that, although they have LiBOB added, have a low battery capacity.

In view of such a problem, stainless steel, which because of problems with weight and processability has not been used as a constituent material of the container in the related art, is used as a constituent material for at least part of the container 10 in the nonaqueous electrolyte secondary battery 1. Thanks to this, the container 10 will not be prone to be damaged even if the nonaqueous electrolyte secondary battery 1 heats up in the event of trouble. Thus, the battery has improved thermal stability. In the interest of realizing further improved thermal stability, at least the container body 11 of the container 10 will preferably be formed using stainless steel, and further preferably, substantially the whole of the container 10 will be formed using stainless steel.

With at least part of the container 10 formed using stainless steel, the rigidity of the container 10 will be enhanced. Thanks to this, for example, when a plurality of nonaqueous electrolyte secondary batteries 1 are used stacked in the thickness direction, the rigidity will be lower that is required of a stacking member pressing and fixing the stacked nonaqueous electrolyte secondary batteries 1. This enables decrease in weight of the stacking member. Hence, at least part of the container 10 formed using stainless steel enables decrease in weight of a stack of the nonaqueous electrolyte secondary batteries 1.

“Stainless steel” refers to an iron alloy that contains at least nickel. Specific examples of such stainless steel are: an iron alloy that contains nickel, chromium, and manganese; an iron alloy that contains nickel and chromium; an iron alloy that contains nickel, chromium, and molybdenum; an iron alloy that contains chromium; an iron alloy that contains chromium and aluminum; an iron alloy that contains chromium, and titanium or niobium; and an iron alloy that contains nickel, chromium, copper, and niobium.

It will suffice for LiBOB to be present in the electrolyte immediately after the nonaqueous electrolyte secondary battery has been assembled. For example, after charge-discharge has been performed following assembly, the LiBOB may in some cases be present in the form of a LiBOB alteration. In other cases, at least a part of the LiBOB or the LiBOB alteration may be present on the negative electrode active material layer. Such cases are included in the technical scope of the invention.

What is claimed is:

1. A prismatic nonaqueous electrolyte secondary battery with a battery capacity not less than 15 Ah, comprising:
an electrode assembly including a positive electrode, a negative electrode opposed to the positive electrode, and a separator disposed between the positive electrode and the negative electrode;
a nonaqueous electrolyte containing lithium bis(oxalato)borate (LiBOB); and
a container housing the electrode assembly and the nonaqueous electrolyte, and having at least part thereof formed using stainless steel.

2. The nonaqueous electrolyte secondary battery according to claim 1, wherein the content of the LiBOB before the first charging in the nonaqueous electrolyte is not less than 0.05 mol/L .

3. The nonaqueous electrolyte secondary battery according to claim 1, wherein the thickness of the container is not less than 0.3 mm.

4. The nonaqueous electrolyte secondary battery according to claim 2, wherein the thickness of the container is not less than 0.3 mm.

5. The nonaqueous electrolyte secondary battery according to claim 1, wherein the container has a container body that is a bottomed square tube in shape, an opening and a sealing plate that seals the opening of the container body, and at least the container body of the container is formed using stainless steel.

6. The nonaqueous electrolyte secondary battery according to claim 2, wherein the container has a container body that is a bottomed square tube in shape, an opening and a sealing plate that seals the opening of the container body, and at least the container body of the container is formed using stainless steel.

7. The nonaqueous electrolyte secondary battery according to claim 3, wherein the container has a container body that is a bottomed square tube in shape, an opening and a sealing plate that seals the opening of the container body, and at least the container body of the container is formed using stainless steel.

8. The nonaqueous electrolyte secondary battery according to claim 4, wherein the container has a container body that is a bottomed square tube in shape, an opening and a sealing plate that seals the opening of the container body, and at least the container body of the container is formed using stainless steel.
